(19) United States
(12) Patent Application Publication
(10) Pub. No.: US 2005/0268322 A1
(43) Pub. Date: Dec. 1, 2005

(54) Apparatus and method for utilizing a pre-existing power grid to provide internet access to a home or office or the like

(76) Inventor: Scott F. Watson, Santa Clarita, CA (US)

Correspondence Address: THE WALT DISNEY COMPANY;C/O GREENBERG TRAURIG LLP, 2450 COLORADO AVENUE SUITE 400E, SANTA MONICA, CA, 90404, US

(21) Appl. No.: 11/121,904

(22) Filed: May 3, 2005

Related U.S. Application Data
(60) Provisional application No. 60/568,342, filed on May 4, 2004.

(51) Int. Cl. H04N 7/173

(52) U.S. Cl. 725/130

(57) ABSTRACT

Apparatus and method is disclosed for utilizing the preexisting power grid outside a home or office or the like to provide internet access thereto. A radio is mounted at the power grid adapted to communicate with a radio frequency modem in the home or office. A power line carrier modem is electronically coupled to the radio frequency modem and to a computer in the home or office for delivering internet access thereto.

### CROSS-REFERENCE TO RELATED APPLICATION

This application is a non-provisional application which claims the benefit of provisional application Ser. No. 60/568,342, filed May 4, 2004, the content of which is incorporated by reference herein in its entirety.

### BACKGROUND

1. Field

The disclosure relates to data delivery utilizing a power grid system; and, more particularly, to a method and apparatus for utilizing a pre-existing power grid system leading into a home or office to deliver internet and other services to a consumer at that home or office.

2. Related Art

A significant amount of effort has gone into the development of power line carriers and fixed wire technologies to compete with telephone and cable. Since power grids are ubiquitous, their easy availability has motivated many people to attempt to use the same as an alternative to phone and cable television networks. Unfortunately, power networks were not designed for such communication and the attempts to convert the same into a wide area communications network have not been widely successful. Some of companies working on the Wide Area Network (WAN) problem are PowerWan, Main.Net and Amperion. The primary problem encountered has been the poor transmission characteristics of power lines (they are very lossy) with low signal power limits imposed by the FCC to limit interference. These constraints result in the data traveling only a short distance before needing to be actively relayed by a “repeater.” These repeaters add to latency and cost.

There is a need for a new and cost effective way to deliver internet access to consumers. Since there are typically only 3 wires from the outside world leading into a typical home, i.e., a phone line, a cable television coaxial cable and a power line, and since the phone line and coaxial cable are already used to carry data traffic (DSL and Cable Modems), only the power line is an untapped resource. There is a need to exploit this untapped resource to enable a power company to provide a competitively priced data communication product to a user with limited capital investment.

### SUMMARY

It is an object of this disclosure to utilize a pre-existing power grid system leading into a user's home or office to deliver consumer data services.

It is a further object of this disclosure to combine a fixed wireless system with a power line carrier LAN to deliver data to a home or office.

It is a further object of this disclosure to carry out the foregoing objects by providing a Fixed-Wireless to Powerline Carrier bridge in a power meter collar so that the system can be installed in minutes by a power company's meter readers and field representatives without need for drilling or other mounting.

It is another object of this disclosure to carry out the foregoing object utilizing outdoor installation to get data into the home or office without need for additional wires to the home of office.

### DRAWINGS

The above-mentioned features and objects of the present disclosure will become more apparent with reference to the following description taken in conjunction with the accompanying drawings wherein like reference numerals denote like elements and in which:

FIG. 1 is an exploded view of a bridge device used to carry out the teachings of the disclosure;

FIG. 2 is an assembled view of the parts of FIG. 1;

FIG. 3 is a view similar to FIG. 1 showing the device of FIG. 1 with a filter disposed therein; and

FIG. 4 is a schematic illustration of the apparatus of the invention used in conjunction with multiple dwelling units.

### DETAILED DESCRIPTION

In recent years, some progress has been made in power line carrier technology for “local area network” (LAN) applications, especially in the home or office. The most popular technology is that endorsed by “The Homeplug Powerline Alliance,” commonly referred to as Homeplug. Homeplug converts a user's home power lines into a LAN, which makes for a good consumer experience because no new wires are required and there is typically a power outlet wherever one would want a network connection.

“Fixed-Wireless” is another technology which holds promise as an inexpensive way to provide data services over a wide area. Fixed-wireless refers to wireless devices or systems that are situated in fixed locations, such as a home or office, as opposed to devices that are mobile, such as cellular telephones and personal digital assistants (PDAs). Fixed-Wireless technologies work similar to cell phones, except they are intended to bridge two fixed locations. By requiring the end-point to be fixed, there are two primary system advantages:

1. Passive directional (2-6 dBi) antennas can be used on the client side, since the user can adjust the antenna's location for optional reception.

2. Active high gain antennas (i.e., phased arrays) can be used on the base station.

Theoretically, the gain provided by these antenna systems allows a single base station to serve a larger cell relative to normal cell phone technologies. This is important since increased cell size means fewer cells, and proportionately lower installation and operating costs. However, these benefits are largely offset by the need for the system to work reliably indoors and without any professional installation. This combination of an outdoor antenna and professional installation has in fact yielded cell radii in excess of 15 miles.

Power meters associated with a home power system generally consist of two components. The first component is the base, which is usually a dumb piece of plastic and metallic material, which is attached to the residence and to the main junction box. The second component is the meter itself, which is typically electromechanical, and is designed to plug into the base.

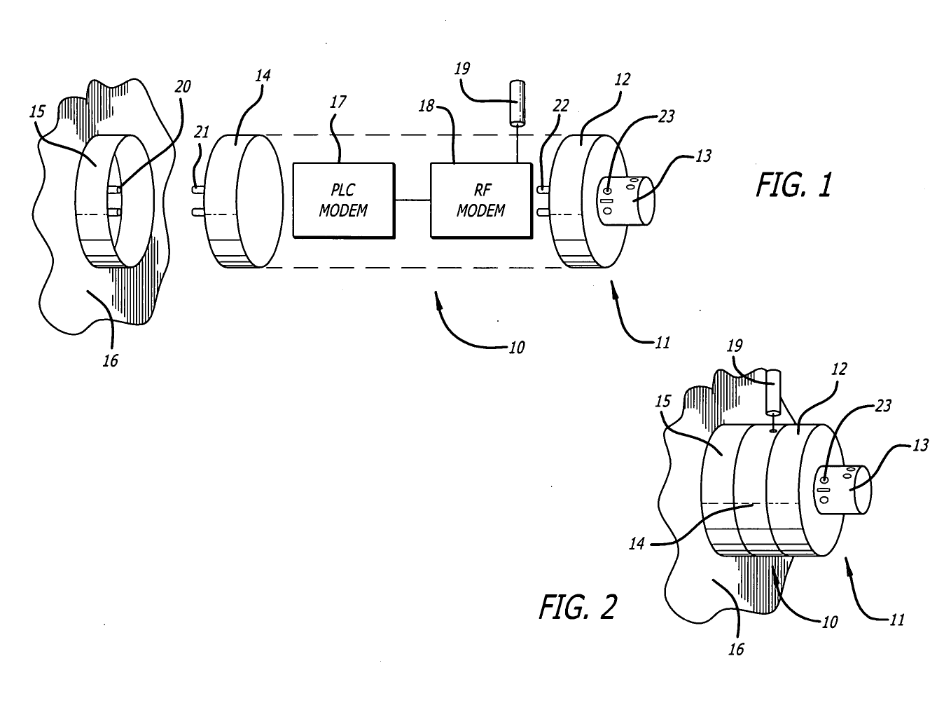

The invention herein contemplates using the pre-existing power lines coming into a home or office as the basis for an internet access delivery system. Thus, the present disclosure, as seen in FIG. 1, includes a bridge device 10, shown in exploded view, which is comprised of a conventional power meter apparatus 11 which includes a mounting plate 12 and a conventional power meter 13 to measure power consumption. Meter 13 has suitable power measuring indicia 23 thereon. A collar 14 is provided adapted to contain the main components of the disclosure. This meter collar 14 is preferably a standardized piece of a non-conductive plastic material which is disposed between a base 15, which is attached to the wall 16 of a home or office or the like, inside or outside.

Inside of collar 14, when assembled (FIG. 2), there is a power line carrier modem 17 (see also FIG. 1), and a bidirectional radio frequency modem 18 (a fixed, wireless modem). As seen in FIG. 2, a small directional antenna 19 is connected to the bidirectional radio frequency modem 18. This antenna 19 may be provided directly on modem 18 or remote therefrom, such as on a roof, but electronically coupled thereto.

Suitable electronic connections are provided between the various components, as indicated by connectors 20 on base 15, connectors 21 extending from collar 14, and connectors 22 extending from the plate 12 of power meter apparatus 11.

Thus, the pre-existing properties of a power grid system are used to deliver consumer data services to a consumer's home or office. The first hop is a “fixed wireless” communication which communicates between the radio frequency modem 18 via antenna 19 and a radio (not shown) mounted on or near the power grid outside of the home or office. The radio may have an active high gain antenna. The second hop is the interconnected power line carrier modem 17 between the radio and the user's devices in the home or office, such as a computer, etc.

There is thus disclosed a new, cost effective way to deliver internet access to consumers utilizing a home or office's pre-existing power grid.

It is to be understood that suitable electronics and software may be provided to pass data between the modems 17, 18 for delivery to a computer or the like in the home.

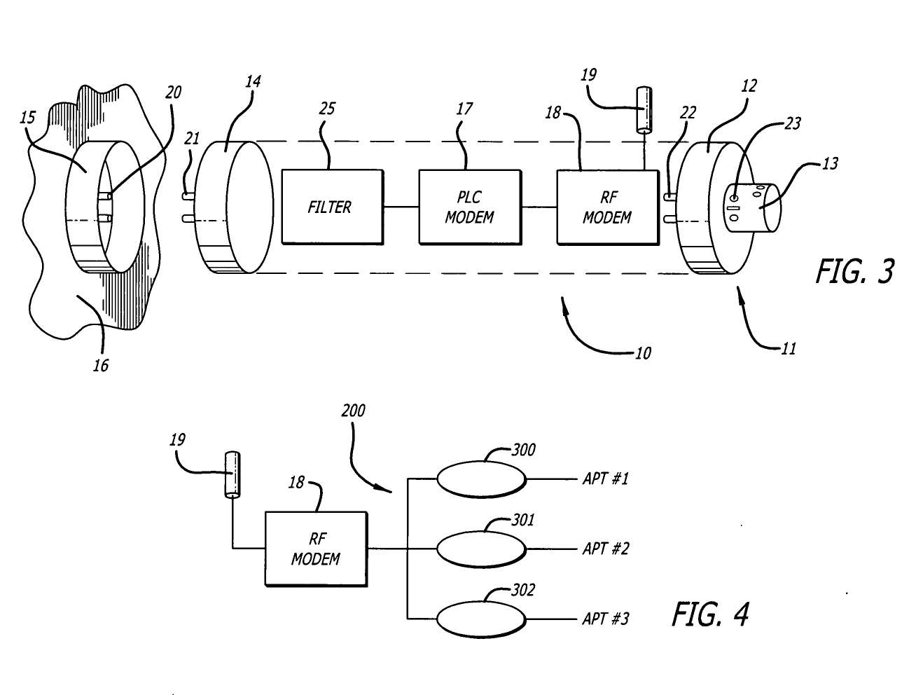

The bridge device 10 may be installed inside or outside a home or office. Outdoor installation allows the fixed wireless system to work better since it avoids the signal attenuation associated with indoor reception. The antenna can either be mounted on the roof of the home or office or on an eave associated with the roof and electronically coupled to the modem 18 of a plurality of bridge devices 10. With multiple dwelling unites, such as apartments, the antenna 19 (FIG. 1) may be separate and apart from the modem 18, but electronically coupled thereto. For example, as seen in FIG. 4, wherein like parts refer to the embodiment of FIGS. 1 to 3, the antenna 19 is attached to the modem 18, but modem 18 is coupled to a local area network 200 having a unit 300 to 302, similar to unit 10 of FIG. 1, but without modem 18, associated with apartments 1, 2 and 3 in a multiple dwelling unit. Thus, in this arrangement, the “first hop” is shared and a wired networking protocol is used to share the “first hop” connection among multiple broadband over power line connections. If desired, filters may be provided in the bridge device 10 to stop data from going out to the public. This is shown in FIG. 3 wherein the device 25 (otherwise identical to device 10 of FIG. 1) shows a conventional screening filter 24 disposed in the bridge device 25.

The bridge devices 10 and 25 may be sold as a self-contained unit ready to be plugged into any suitable electrical outlet in a home or office or the like.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. Apparatus for utilizing a pre-existing power grid outside of a home or office or the like to deliver data services to a home, office or the like comprising:
a radio mounted at the power grid; and
a bridge device mounted at a location remote from said radio, said bridge device including a radio frequency modem electronically coupled to a conventional power meter, said radio frequency modem having an antenna electronically communicating with said radio for receiving electrical signals emitted by said radio, said bridge device further including a power line carrier modem electronically coupled to both said radio and said radio frequency modem.

2. The apparatus of claim 1, wherein said bridge device is electronically coupled to a computer or the like to deliver data received from said radio to said computer or the like.

3. The apparatus of claim 1, wherein said bridge device is electronically coupled to a computer or the like to receive data from said computer for transmission to said radio.

4. The apparatus of claim 1, wherein said radio frequency modem is a bidirectional fixed wireless modem.

5. The apparatus of claim 1, wherein said antenna is a small directional antenna.

6. The apparatus of claim 1, wherein said antenna is mounted on the roof of the home or office.

7. Apparatus for utilizing a pre-existing power grid to deliver data services to a home or office or the like, wherein said apparatus includes a fixed wireless modem power meter coupled to the power grid for recording power usage from said grid, said power meter being adapted to be installed at the home or the like remote from said power grid, the apparatus including:
a bridge device electronically coupled to said power meter, said bridge device electronically coupled to a base mounted at said home or office, said bridge including a radio frequency modem having an antenna, said antenna being electronically coupled to both said power meter and a power line carrier modem electronically coupled to said base.

8. In the apparatus of claim 7, wherein said radio frequency modem is a bidirectional fixed wireless modem.

9. In the apparatus of claim 7, wherein said antenna is a small directional antenna.

10. In the apparatus of claim 7, wherein said antenna is mounted on the roof of the home or office.

11. A bridging device for utilizing the power generated by a power grid system for delivering internet services to a consumer at a home or office comprising:
a radio frequency modem coupled to a power meter having an antenna adapted to communicate with said power grid system; and
a power line carrier modem electronically coupled to said radio frequency modem adapted to be electronically coupled to a base mounted at said home or office.

12. The bridging device of claim 11, wherein said modems are mounted in a collar.

13. The apparatus of claim 11, wherein said power line carrier modem receives said data from said system and transmits said data to a computer in said home or office.

14. The bridging device of claim 11, wherein said antenna is a small directional antenna.

15. The bridging device of claim 11, wherein said antenna is mounted on the roof of the home or office.

16. The bridging device of claim 11, wherein said radio frequency modem is a bidirectional fixed wireless modem.

17. The bridging device of claim 11, including a plurality of power line carriers coupled to said radio frequency modem, each of said power line carriers being separately electronically coupled to a differing base associated with an apartment in a multiple dwelling unit.

18. A method for utilizing a pre-existing power grid having a power system demarcation point that delivers electrical power to a home or office or the like comprising the steps of:
providing a radio at or near said demarcation point;
providing a power line carrier modem at said home electronically coupled to a base at said home or office, said base being adapted to deliver data to a computer modem when coupled thereto; and
providing a radio frequency modem having an antenna adapted to receive signals from said radio electronically coupled to both said power line carrier modem and a conventional power meter electronically coupled to said power system for recording power usage.

19. The method of claim 18 wherein the step of providing a radio frequency modem includes the step of providing a bidirectional fixed wireless modem.

20. The method of claim 18 wherever the step of providing a radio frequency modem having an antenna includes the step of providing a radio frequency modem with a small directional antenna adapted to receive signals from said radio.

21. The method of claim 18, wherein the step of providing a power line carrier modem includes the step of providing a plurality of power line carrier modems all electronically coupled to said radio frequency modem, each of said power line carrier modems being electronically coupled to a differing based in said home or office.
